(19) United States
(12) Patent Application Publication
(10) Pub. No.: US 2009/0129209 A1
(43) Pub. Date: May 21, 2009

(54) WATCH MOVEMENT OF THE FLY-BACK CHRONOGRAPH TYPE AND TIMEPIECE PROVIDED WITH SUCH A MOVEMENT

(76) Inventor: Jean-Pierre GOLAY, Sion (CH)

Correspondence Address: OSTROLENK FABER GERB & SOFFEN, 1180 AVENUE OF THE AMERICAS, NEW YORK, NY, 100368403, US

(21) Appl. No.: 12/275,889

(22) Filed: Nov. 21, 2008

(30) Foreign Application Priority Data
Nov. 21, 2007 (CH) 2007 1799/07

(51) Int. Cl. G04B 19/06

(52) U.S. Cl. 368/80

(57) ABSTRACT

A description is given of a watch movement of the fly-back chronograph type comprising a frame carrying connected a finishing gear train capable of being train kinematically to a chronograph gear train comprising at least one chronograph runner having a chronograph spindle intended to carry a first member for displaying seconds. The movement comprises a fly-back runner coaxial with the chronograph runner and having a fly-back spindle intended to carry a second member for displaying seconds. The fly-back spindle is hollow and passed through by the chronograph spindle, the fly-back runner being mounted rotationally with reference to the frame by means of a bearing. Among other advantages, this construction makes it possible to isolate the chronograph runner from the fly-back runner.

### TECHNICAL FIELD

The present invention relates to a watch movement of the fly-back chronograph type comprising a frame carrying a finishing gear train capable of being connected kinematically to a chronograph gear train. In a known manner, the latter comprises at least one chronograph runner having a chronograph spindle intended to carry a first member for displaying seconds, the movement also comprising a fly-back runner coaxial with the chronograph runner and having a fly-back spindle intended to carry a second member for displaying seconds.

The invention also relates to a timepiece provided with such a movement.

### PRIOR ART

Such watch movements are known in the prior art. By way of example, it should be noted that the work entitled “Théorie d'horlogerie” [“Watchmaking theory”], by C.-A. Reymondin et al., published by the Fédération des Ecoles Techniques (Switzerland), ISBN 2-940025-10-X, describes a conventional movement of this type, on pages 249 to 251.

Typically, in a fly-back movement the chronograph gear train is conventional apart from the fact that the spindle of the chronograph runner is hollow in order to accommodate the spindle of the fly-back runner which passes right through it. The fly-back runner generally comprises a wheel disposed at the back of the movement, that is to say on the bridge side, and carrying a fly-back lever intended to cooperate with a heart-shaped cam fixed to the chronograph runner, under the effect of the action of a fly-back spring also carried by the wheel. This cooperation provides the superposition of a fly-back hand on a first hand for indicating a time unit, in principle the second.

A fly-back clamp comprising at least one brake is provided in order to lock the fly-back runner by immobilising its wheel, in response to an action of a user of the corresponding timepiece, and to stop the fly-back hand whilst the first indicating hand continues running.

In general, the fly-back runner is pivoted, at the centre of the movement, in a fly-back bridge whilst the hollow spindle of the chronograph runner also fulfils a guidance function for its spindle. The spindle of the chronograph runner is also pivoted in a bearing fixed to the plate of the movement.

These constructions, however, have a number of drawbacks.

On the one hand, the fact that the fly-back spindle is pivoted in the chronograph spindle has the direct consequence of retransmitting all the forces experienced by the fly-back runner onto the chronograph runner, in particular the impacts due to the pressing of the fly-back lever on the heart-shaped cam of the chronograph runner and the friction created by a possible imbalance of the action of the fly-back clamp or clamps on the wheel of the fly-back runner.

The most common movements use a clamp formed by a pair of brakes for locking the fly-back runner in order to balance as much as possible the stresses experienced by the fly-back wheel during immobilisation and de-immobilisation operations. These clamp-based mechanisms are however complex to assemble and adjust with all the required accuracy.

Moreover, the continuous friction of the fly-back lever on the heart-shaped cam also disturbs the movement of the chronograph runner.

In order to respond to this last problem, isolating mechanisms have been proposed, such as for example in the patent CH 686 545G A3. However, these mechanisms do not offer a solution to the first problem raised above.

### DISCLOSURE OF THE INVENTION

One aim of the present invention is to overcome the above-mentioned problems of the prior art by proposing a fly-back chronograph movement in which the operation of the fly-back runner affects as little as possible the operation of the chronograph runner with which it is associated. In other words, it is a question of proposing a construction by which the chronograph runner is isolated as much as possible from the fly-back runner.

To that end, the fly-back chronograph movement according to the invention is characterised by the fact that the fly-back spindle is hollow and passed through by the chronograph spindle, the fly-back runner being mounted rotationally with reference to the frame by means of a bearing.

By virtue of this construction, the spindle of the chronograph runner is free to turn inside the spindle of the fly-back runner which has an improved stability with reference to those of the movements of the prior art on account of it being pivoted directly in an element of the frame. Improving the stability of the fly-back runner makes it possible in particular to resort to the use of a single brake, simpler to assemble than in the case of clamps, without for all that disturbing the operation of the chronograph runner.

Preferably, the first and second members for displaying seconds are arranged to pivot according to a first axis of rotation, the movement also comprising at least one member for displaying the current hours and one member for displaying the current minutes, these being arranged to pivot according to at least one second axis of rotation, the first axis of rotation being situated at a distance from the second axis of rotation.

Such a construction, original since the first and second members for displaying seconds are conventionally disposed at the centre of the movement, being coaxial with the hands for displaying the current time, makes it possible to further improve the stability of the assembly of the first and second members for displaying seconds.

According to a preferred embodiment, the wheels of the chronograph runner and of the fly-back runner are adjacent without the interposition of an element of the frame between them. The fly-back wheel typically comprises a fly-back lever having a contact surface intended to cooperate with the periphery of a heart-shaped cam fixed to the chronograph runner. The characteristic of the invention mentioned above makes it possible to arrange the fly-back lever in such a way that it cooperates directly with the reset-to-zero heart-shaped cam of the chronograph runner, instead of providing an additional heart-shaped cam as is the case in the movements of the prior art.

Advantageously, the fly-back runner can be mounted pivoting in a ball bearing housed in a bridge mounted on the plate of the movement, on its dial side.

### BRIEF DESCRIPTION OF THE DRAWINGS

Other characteristics and advantages of the present invention will emerge more clearly from a reading of the following detailed description of a preferred embodiment, produced with reference to the accompanying drawings given by way of non-limiting examples and in which:

FIG. 1 depicts a simplified plan view, on the dial side, of a preferred embodiment of a movement for a timepiece according to the present invention;

FIG. 2 depicts a simplified plan view, on the dial side, of a constructional detail of the movement of FIG. 1, in a first configuration;

FIG. 3 depicts a simplified plan view similar to the view of FIG. 2, the movement being visible in a second configuration; and

FIG. 4 depicts a simplified sectional view, along the line IV-IV of FIG. 1, of a constructional detail of the movement of FIGS. 1 to 3 in the first configuration of FIG. 2.

### EMBODIMENT(S) OF THE INVENTION

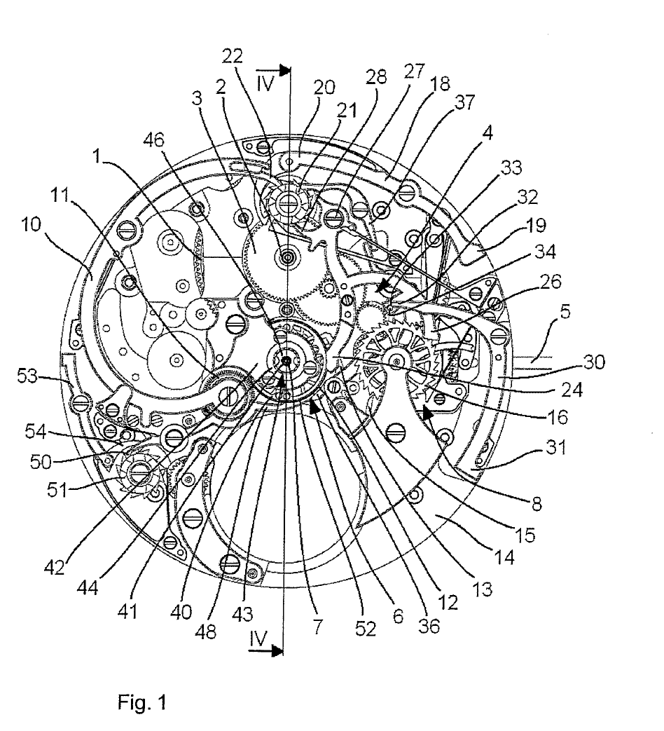

FIG. 1 depicts a simplified plan view, on the dial side, of a preferred embodiment of a movement for a timepiece according to the present invention.

This movement comprises a finishing gear train, not depicted, connecting a mechanical energy source, illustrated in the form of a barrel 1 housing a spring, to a mechanical oscillator, not depicted. The finishing gear train is adapted to rotationally drive a cannon pinion 2 and an hour wheel 3 intended to carry, respectively, a minute hand and an hour hand.

The movement also comprises a conventional winding and setting gear train 4, controlled using a setting stem 5.

Furthermore, this movement is provided with a chronograph function. To that end, it comprises in particular a chronograph runner 6 intended to carry a hand for indicating seconds of measured times, by means of its spindle 7, and a minute runner 8 intended to carry a hand for indicating minutes of measured times.

A coupling rocker 10, carrying an intermediate coupling wheel 11, is provided for establishing a kinematic link between the finishing gear train and a wheel 12 of the chronograph runner 6, or for breaking it.

In a known manner, the movement comprises a rocker 13 pivoted on the plate 14 and carrying a finger 15 for driving the wheel 16 of the minute runner 8 by one step at each complete revolution of the chronograph runner 6.

Uncoupling and coupling of the chronograph are carried out by means of a control 18 having a first end 19, positioned at two o'clock and intended to cooperate with a pushbutton (not depicted), and a second end 20, carrying a hook acting on a column wheel 21 in order to make it turn by one step (in the clockwise direction in FIG. 1) in response to each press of a user on the pushbutton.

FIG. 1 depicts the movement while the chronograph function is activated. In this case, one end 22 of the coupling rocker 10 rests on a column of the column wheel 21, which positions the intermediate coupling wheel 11 engaged with the wheel 12 of the chronograph runner 6. When the user presses the pushbutton acting on the control 18, thus making the column wheel 21 turn by one step, the end 22 of the coupling rocker falls between two columns, at the same time releasing the intermediate coupling wheel 11 from the wheel 12.

The movement of FIG. 1 also comprises a mechanism for resetting the measured time second and minute counters to zero. This mechanism comprises in particular hammers 24 and 26 for the seconds and minutes, here formed in a single piece by way of a non-limiting illustration. These hammers are mounted pivoting on the plate 14 by means of a shouldered screw 27 and are fixed to a projection 28 intended to cooperate with the column wheel 21.

In the configuration depicted, the projection 28 is resting on a column in order to position the hammers 24 and 26 in the up position, since a time measurement is in progress. The reset-to-zero mechanism also comprises a reset-to-zero control 30 having a first end 31 positioned at four o'clock and intended to cooperate with an additional pushbutton for lowering the hammers 24 and 26. This control 30 has a second end 32 having a notch 33 cooperating with a pin 34 fixed to the hammers.

The function of this notch 33 is to keep the hammers in the up position when the time measurement is stopped by the user. Pressing on the additional pushbutton then has the effect of freeing the pin 34 and lowering the hammers 24 and 26 under the effect of the action of a spring, not depicted.

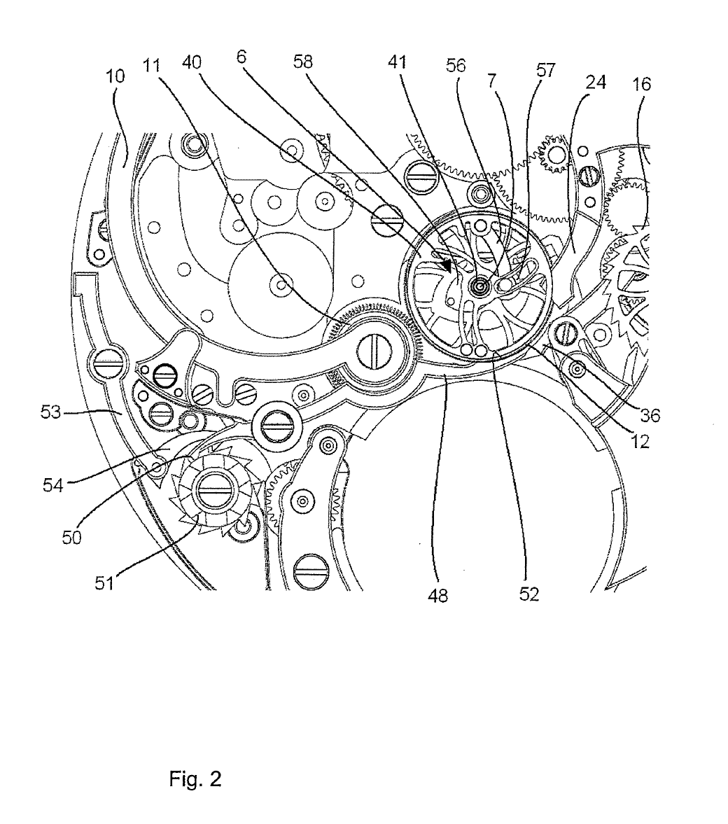

The hammers then cooperate with heart-shaped cams (one of which is visible in FIGS. 2 to 4) in order to reset the second and minute counters to zero, in a conventional manner.

A further press on the first pushbutton has the effect of turning the column wheel 21, one column of which then lifts the projection 28 fixed to the hammers, bringing about the release of the heart-shaped cams, until the pin 34 returns to take up a position inside the notch 33.

It should be noted that the movement also comprises a conventional brake 36, controlled from the column wheel 21 by means of a rocker 37, in order to immobilise the wheel 12 of the chronograph runner during the stop and time measurement phases.

In accordance with the present invention, the movement also comprises a fly-back mechanism whereof the operation will be described in detail in conjunction with FIGS. 2 to 4. This mechanism comprises a fly-back runner having a fly-back wheel 40 coaxial with the wheel 12 of the chronograph runner 6 and fixed to a fly-back spindle 41 intended to carry a fly-back hand (not depicted). The fly-back spindle is hollow, the spindle 7 of the chronograph runner 6 being disposed inside the hollow.

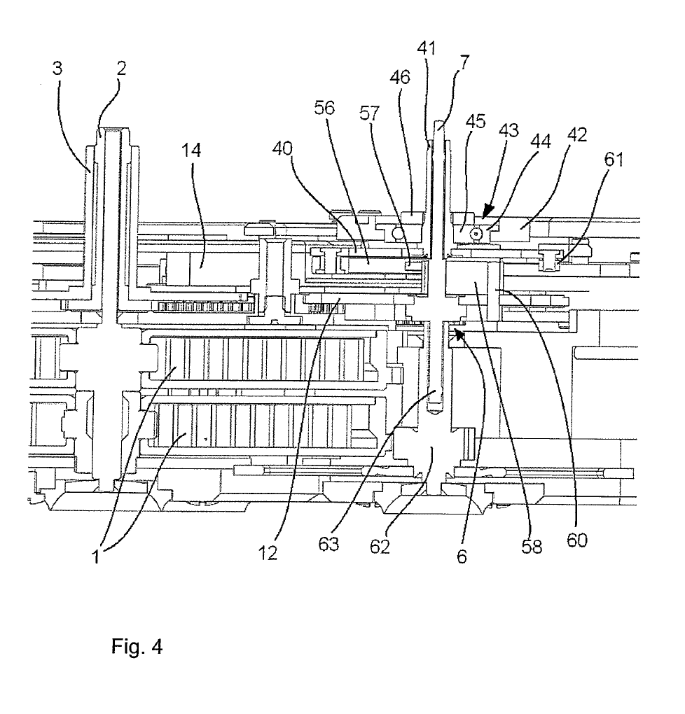

It can be seen from FIG. 1 that a fly-back bridge 42 is assembled on the plate 14 of the movement, this bridge carrying a ball bearing 43 having an outer race 44 friction-mounted in the bridge 42 and an inner race (reference 45 in FIG. 4) in which the fly-back spindle is friction-mounted. The corresponding assembly is assembled with the movement by means of a nut 46, by way of a non-limiting illustration.

It should be noted that, according to the preferred embodiment as depicted, the chronograph runner and fly-back runner are pivoted according to a first axis of rotation situated at a distance from a second axis of rotation according to which the cannon pinion and the hour wheel are mounted pivoting (the various display members have been shown schematically by dotted lines in FIG. 1).

The mechanism also comprises a fly-back brake 48 mounted pivoting on the plate 14 of the movement and controlled by an additional column wheel 51. To that end, the brake 48 comprises a projection 50 arranged at a first end in order, in a first configuration, to rest on a column of the additional column wheel 51 and, in a second configuration, to go down into the space separating two adjacent columns.

The brake also comprises, at its opposite end, a single contact surface 52 arranged to cooperate with the periphery of the fly-back wheel 40 in order to lock it when the projection 50 is not resting on a column of the additional column wheel. When the projection is raised and is resting on a column, the fly-back wheel is free to turn and takes up a position in a predefined angular position with reference to the wheel 12 of the chronograph runner 6, as will be described later.

A third, fly-back, control 53 is provided for cooperating with a third pushbutton (not depicted), here at nine o'clock. This control comprises a hook 54 arranged to act on the additional column wheel 51 in order to make it turn by one step (in the anticlockwise direction in FIG. 1) each time the user presses the third pushbutton, and make the brake pivot in one direction or the other.

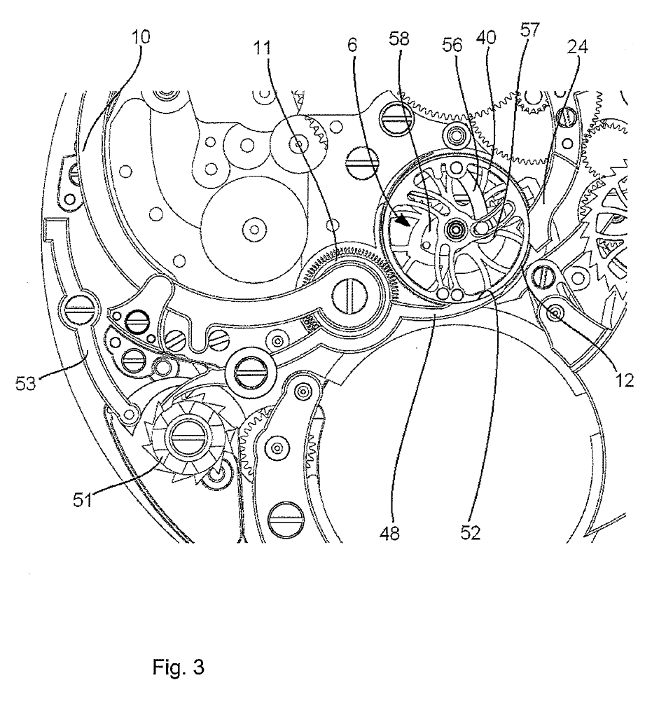

FIGS. 2 and 3 depict simplified plan views, on the dial side, of a constructional detail of the movement of FIG. 1, in respectively a first and a second configuration, making it possible in particular to show the operation of the fly-back mechanism.

The configuration of FIG. 2 corresponds to that of FIG. 1, namely that a time measurement is in progress and the fly-back runner is free to turn in order to superpose the fly-back hand on the chronograph hand.

To that end, the fly-back wheel 40 carries a fly-back lever 56, mounted pivoting in proximity to the periphery of the wheel. The fly-back lever carries a cylindrical roller 57 arranged to roll on the periphery of a heart-shaped cam 58 fixed to the chronograph runner 6, under the effect of the action of a fly-back spring (visible in FIG. 4), in a known manner. Thus, when the fly-back wheel 40 is free to turn, as depicted in FIG. 2, it takes up a position angularly with respect to the heart-shaped cam 58 in such a way that the roller 57 is situated resting against the portion with the smallest radius. In this position, the chronograph and fly-back hands are superposed.

When the fly-back control 53 is actuated, the configuration of the movement becomes that of FIG. 3. The additional column wheel 51 turns by one step, and the fly-back brake 48 is then lowered onto the fly-back wheel 40 in order to immobilise it while the chronograph runner continues its rotation. The fly-back hand is stopped while the chronograph hand continues to turn.

At the same time, the radius of the heart-shaped cam 58 opposite which the roller 57 is situated increases which raises the fly-back lever 56 against the force exerted by the fly-back spring.

In the case of a further action on the control 53, the additional column wheel 51 turns again by one step, which brings about the freeing of the fly-back wheel 40 by the brake 48. At that moment, the fly-back spring can act to press the roller 57 against the periphery of the heart-shaped cam 58 so as to again put it in the position of FIG. 2. The hands are then once again superposed.

FIG. 4 depicts a simplified sectional view, along the line IV-IV of FIG. 1, of a constructional detail of the movement that has just been described in conjunction with FIGS. 1 to 3, in the first configuration of FIG. 2. This figure makes more obvious the interactions between the elements mentioned previously, in particular between the chronograph runner 6 and the fly-back runner.

It can be seen in particular from this figure that the heart-shaped cam 58 is made fixed to the chronograph wheel 12 by means of a pin 60, in a conventional manner. Similarly, the fly-back spring 61 is riveted in the fly-back wheel 40 in accordance with the assemblies of the prior art.

It is also evident that the chronograph runner 6 pivots, on the one hand, in a central runner 62 of the finishing gear train by its end 63 situated inside the movement and, on the other hand, in the fly-back spindle 41, the latter pivoting in the ball bearing 43, in accordance with the present invention.

By virtue of this construction, the fly-back runner has increased stability compared with the known mechanisms of the prior art.

Because of this, the use of a single fly-back brake 48 does not compromise the working of the chronograph runner whilst allowing simplification of its manufacture and assembly compared with the use of a fly-back clamp using two opposing brakes.

Furthermore, it should be noted that the advantageous construction of the movement according to the present invention proposes disposing the chronograph wheel 12 and fly-back wheel 40 in such a way that they are adjacent, without the interposition of an element of the frame between them.

By virtue of this particular characteristic, it is possible to provide only a single heart-shaped cam 58 in order to both reset the chronograph counter to zero, by means of the hammer 24, and index the angular position of the fly-back hand onto that of the chronograph hand, by means of the fly-back lever 56. As a reminder, it should be noted that the movements of the prior art provide a first heart-shaped cam to provide resetting to zero of the chronograph counter and a second heart-shaped cam to provide indexing of the fly-back hand, which, of course, implies complications as regards both manufacture and assembly of the movement.

The preceding description attempts to describe a particular embodiment by way of a non-limiting illustration and the invention is not limited, for example, to the disposition of the chronograph gear train on the bridge side of the movement or to the use of a ball bearing for assembling the fly-back runner with the frame of the movement. Similarly, the preceding description relates to a fly-back hand associated with a chronograph runner, intended to display the measured time seconds, but persons skilled in the art will not encounter any particular difficulty in using the principles described here, according to their own needs, like for example in order to associate a fly-back hand with the measured time minutes counter.

Furthermore, neither will persons skilled in the art encounter any particular difficulty in adapting any known fly-back isolating mechanism with the movement that has just been described, such as for example that of the patent CH 686 545G A3 already mentioned, without departing from the scope of the present invention.

What is claimed is:

1. Watch movement of the fly-back chronograph type comprising a frame carrying a finishing gear train capable of being connected kinematically to a chronograph gear train comprising at least one chronograph runner having a chronograph spindle intended to carry a first member for displaying seconds, the movement comprising a fly-back runner coaxial with said chronograph runner and having a fly-back spindle intended to carry a second member for displaying seconds,
wherein said fly-back spindle is hollow and passed through by said chronograph spindle, said fly-back runner being mounted rotationally with reference to said frame by means of a bearing.

2. Movement according to claim 1, a heart-shaped cam being fixed rotationally to said chronograph spindle and intended to cooperate via its periphery with a reset-to-zero hammer in order to position said first display member in a predefined rest position,
wherein said fly-back runner comprises a wheel carrying a fly-back lever having a contact surface arranged to be kept in continuous contact with the periphery of said heart-shaped cam under the action of elastic means in order to provide superposition of the first and second display members, the movement also comprising an immobilising member having a surface intended to cooperate with said fly-back runner, in response to an action of a user, in order to lock said second display member in a given position.

3. Movement according to claim 2, wherein said immobilising member comprises a single brake having a surface having substantially the shape a portion of and intended to cooperate with the wheel of said fly-back runner.

4. Movement according to claim 1, wherein said bearing is arranged between said wheel of the fly-back runner and the end of its spindle intended to carry said second display member.

5. Movement according to claim 1, wherein said bearing comprises a roller bearing having a first race fixed to said frame and a second race fixed to said fly-back spindle.

6. Movement according to claim 5, wherein said roller bearing is carried by a bridge assembled on the plate of the movement, on its dial side.

7. Movement according to claim 5, wherein said roller bearing is a ball bearing.

8. Movement according to claim 1, wherein said chronograph runner is guided rotationally, on the one hand, by having a first end, situated in the movement, housed inside a spindle of a runner of said finishing gear train and, on the other hand, by said fly-back spindle.

9. Movement according to claim 1, said chronograph runner having a chronograph wheel, wherein said chronograph wheel and said wheel of the fly-back runner are adjacent without the interposition of an element of said frame between them.

10. Movement according to claim 1, said first and second members for displaying seconds being arranged to pivot according to a first axis of rotation, the movement also comprising at least one member for displaying the current hours and one member for displaying the current minutes, these being arranged to pivot according to at least one second axis of rotation, wherein said first axis of rotation is situated at a distance from said second axis of rotation.

11. Timepiece comprising a case closed by a glass through which at least first and second members for displaying seconds are visible, wherein a watch movement according to claim 1 is housed in said case in order to drive said first and second display members.
